(19) United States
(12) Patent Application Publication
(10) Pub. No.: US 2026/0142928 A1
(43) Pub. Date: May 21, 2026

(54) VARIABLE TIMEOUT FOR CONGESTION CONTROL IN A COMMUNICATIONS PROTOCOL

(71) Applicant: QUALCOMM Incorporated, San Diego, CA (US)

(72) Inventor: Umed Singh RANA, Faridabad (IN)

(21) Appl. No.: 18/952,861

(22) Filed: Nov. 19, 2024

(51) Int. Cl. H04L 47/28; H04L 47/12

(52) U.S. Cl. CPC H04L 47/28; H04L 47/12

(57) ABSTRACT

Systems and techniques are described for wireless communications. For example, a first device can receive, from a second device, a request for data. The request includes an indication of an extended amount of time for responding to the request with a response comprising an acknowledgement of receiving the request and the data. The first device can determine, based on receiving the request, whether the response comprising the acknowledgment and the data can be transmitted by the first device within the extended amount of time.

### FIELD

The present disclosure generally relates to wireless communications. For example, aspects of the present disclosure relate to a variable timeout for congestion control in a communications protocol, such as the constrained application protocol (CoAP).

### BACKGROUND

Devices, including computing devices and servers, can communicate with each other via communications protocols. A constrained application protocol (CoAP) is one such communications protocol that is used for these types of communications. CoAP is a widely used application protocol designed for a constrained (e.g., low power and lossy) network including constrained nodes. Similar to the hypertext transfer protocol (HTTP), CoAP is based on a request-response model. Currently, there are many Internet of Things (IoT) devices that use this protocol for communication with a server within a network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for wireless communications. In some aspects, a first device for wireless communications is provided. The first device includes at least one memory and at least one processor coupled to the at least one processor and configured to: receive, from a second device, a request for data, wherein the request includes an indication of an extended amount of time for responding to the request with a response including an acknowledgement of receiving the request and the data; and determine, based on receiving the request, whether the response including the acknowledgment and the data can be transmitted by the first device within the extended amount of time.

In some aspects, a method of wireless communications is provided. The method includes: receiving, by a first device from a second device, a request for data, wherein the request includes an indication of an extended amount of time for responding to the request with a response including an acknowledgement of receiving the request and the data; and determining, by the first device based on receiving the request, whether the response including the acknowledgment and the data can be transmitted by the first device within the extended amount of time.

In some aspects, a non-transitory computer-readable medium is provided having stored thereon instructions that, when executed by at least one processor, cause the at least one processor to: receive, from a second device, a request for data, wherein the request includes an indication of an extended amount of time for responding to the request with a response including an acknowledgement of receiving the request and the data; and determine, based on receiving the request, whether the response including the acknowledgment and the data can be transmitted by the first device within the extended amount of time.

In some aspects, a first device for wireless communications is provided. The first device includes: means for receiving, from a second device, a request for data, wherein the request includes an indication of an extended amount of time for responding to the request with a response including an acknowledgement of receiving the request and the data; and means for determining, by the first device based on receiving the request, whether the response including the acknowledgment and the data can be transmitted by the first device within the extended amount of time.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the devices (or apparatuses) described herein is, is a part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a personal computer, a laptop computer, a server, a video server, a television (e.g., a network-connected television), a vehicle (or a computing device or system of a vehicle), user equipment, or other device. In some aspects, the one or more devices can include at least one camera for capturing one or more images or video frames. For example, the one or more devices can include a camera (e.g., an RGB camera) or multiple cameras for capturing one or more images and/or one or more videos including video frames. In some aspects, the one or more devices can include a display for displaying one or more images, videos, notifications, or other displayable data. In some aspects, the one or more devices can include a transmitter (or transceiver) configured to transmit information over a transmission medium to at least one device and a receiver (or transceiver) configured to receive information over the transmission medium from at least one device. In some aspects, at least one processor of one or more of the devices can include a neural processing unit (NPU), a central processing unit (CPU), a graphics processing unit (GPU), a digital signal processor (DSP), and/or other processing device or component.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram of a device, in accordance with some aspects of the disclosure.

FIG. 2 illustrates an example wireless communications system, in accordance with some aspects of the disclosure.

FIG. 3 illustrates an example implementation of a system-on-a-chip (SOC), in accordance with some aspects of the disclosure.

FIG. 4 is a diagram illustrating an example of wireless communications between devices and servers via a communications protocol, in accordance with some aspects of the disclosure.

FIG. 5 is a diagram illustrating an example of a message format for a communications protocol, in accordance with some aspects of the disclosure.

FIG. 6 is a table illustrating an examples of requests with indications of different amounts of time to respond to the requests, in accordance with some aspects of the disclosure.

FIG. 7 is a signaling diagram showing an example of communications between a first device and a second device, where a request from the first device includes an indication of a default amount of time for the second device to respond to the request, in accordance with some aspects of the disclosure.

FIG. 8 is a signaling diagram showing an example of communications between a first device and a second device, where a request from the first device includes an indication of an extended amount of time for the second device to respond to the request, and the second device transmits a response including both an acknowledgement and requested data together, in accordance with some aspects of the disclosure.

FIG. 9 is a signaling diagram showing an example of communications between a first device and a second device, where a request from the first device includes an indication of an extended amount of time for the second device to respond to the request, and the second device transmits a response including an acknowledgement and a subsequent response including requested data, in accordance with some aspects of the disclosure.

FIG. 10 is a flow diagram illustrating an example of a process for a variable timeout for congestion control in a communications protocol, such as the constrained application protocol (CoAP), in accordance with some aspects of the disclosure.

FIG. 11 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, devices (e.g., including computing devices and servers) can communicate with each other via communications protocols. A constrained application protocol (CoAP) is one such communications protocol that is used for these types of communications. CoAP is a widely used application protocol designed for a constrained (e.g., low power and lossy) network including constrained nodes. Similar to the hypertext transfer protocol (HTTP), CoAP is based on a request-response model. Currently, there are many Internet of Things (IoT) devices that use this protocol for communication with a server within a network.

CoAP includes two types of response models, which include a piggybacked response and a separate response. A device can send a piggybacked response, in response to receiving a request for data, when the device is able to obtain the data within a default amount of time for responding to the request. For the piggybacked response, the device can transmit, within the default amount of time, a single response including both an acknowledgement (ACK) of receiving the request and the requested data.

A device can send a separate response, in response to receiving a request for data, when the device is not able to obtain the data within a default amount of time for responding to the request. For example, the device may need extra time to obtain the requested data (e.g., humidity sensor data, biosensor data, etc.) because the device needs to perform a calibration or initialization (e.g., of one or more humidity sensors, biosensors, etc.) before reading the actual data values (e.g., humidity sensor values, biosensor values, etc.). For a separate response, the device can transmit (prior to the expiration of the default amount of time) a first response including an acknowledgement of receiving the request (to notify the requestor that the device received the request, the device is working to obtain the requested data, and that the requestor does not need to retransmit the request to the device), and can transmit (after expiration of the default amount of time) a second response including the requested data. Since these separate responses require double the amount of transmissions (e.g., require two data packet transmissions) than a piggybacked response (e.g., which requires only a single data packet transmission), these additional transmissions of the separate responses can cause a large amount of congestion in the network traffic.

As such, improved systems and techniques that provide a response model for a communications protocol (e.g., CoAP) that can reduce the amount of traffic congestion within a network can be beneficial.

In one or more aspects of the present disclosure, systems, apparatuses, methods (also referred to as processes), and computer-readable media (collectively referred to herein as “systems and techniques”) are described herein that provide solutions for a variable timeout (e.g., within a response model) for congestion control in a communications protocol, such as CoAP.

Various aspects relate generally to wireless communications. Some aspects more specifically relate to systems and techniques that provide solutions for a communications protocol that employ the capability of the piggybacked response method by introducing a new updated extended amount of time for a device to be able to transmit a single response including both the acknowledgment of receiving the request and the requested data. As such, the responding to the request can be performed by the device by using a single packet transfer (as opposed to a double packet transfer), even when the requested data is not available to the device prior to the expiration of the default amount of time for responding to the request.

In one or more aspects, during operation of a method of wireless communications, a first device can receive from a second device, a request for data, where the request includes an indication of an extended amount of time for responding to the request with a response including an acknowledgement of receiving the request and the data. The first device can determine, based on receiving the request, whether the response including the acknowledgment and the data can be transmitted by the first device within the extended amount of time.

In one or more examples, the first device can transmit, to the second device based on determining the response including the acknowledgment and the data can be transmitted within the extended amount of time, the response including the acknowledgement and the data prior to an expiration of the extended amount of time. In some examples, the first device can transmit, to the second device based on determining the response including the acknowledgement and the data cannot be transmitted within the extended amount of time, the acknowledgment and the data in separate transmissions. In one or more examples, the first device can transmit the data subsequent in time to the acknowledgement. In some examples, the first device can transmit the acknowledgement prior to an expiration of the extended amount of time.

In some examples, the transmitting of the request and the transmitting of the response can be via a communications protocol. In one or more examples, the indication of the extended amount of time can be within an options field defined by the communications protocol. In some examples, the communications protocol can be a constrained application protocol (CoAP). In one or more examples, the extended amount of time for responding to the request can be greater than a default amount of time for responding to the request. In one or more examples, the extended amount of time for responding to the request can be based on an amount of time required by the first device to obtain the data.

In one or more examples, the data can be associated with the first device or a third device connected to the first device. In some examples, the first device can be a computing device, and the second device can be a server. In one or more examples, the first device can be a server, and the second device can be a computing device.

Particular aspects of the subject matter described in this disclosure can be implemented to realize one or more of the following potential advantages. In one or more examples, the systems and techniques can provide a benefit of a reduction in traffic congestion in a network, especially in situations where the number of requests are very high, such as in the millions or billions. In some examples, the systems and techniques can provide a benefit of reducing the number of data packets transmitted by devices to half in some cases and, as such, can also provide a savings in power consumption of the devices because the devices will be performing less transmissions.

Additional aspects of the present disclosure are described in more detail below.

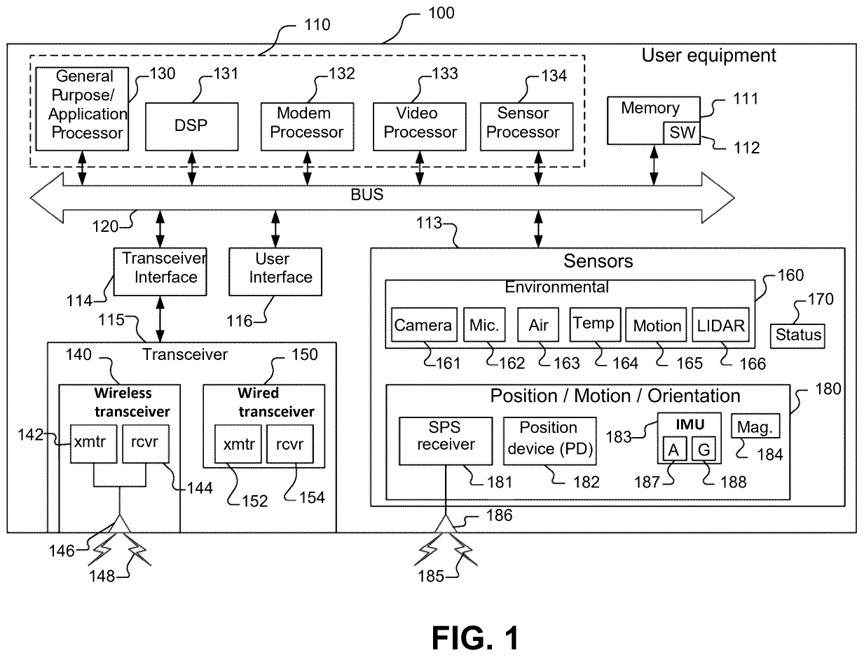

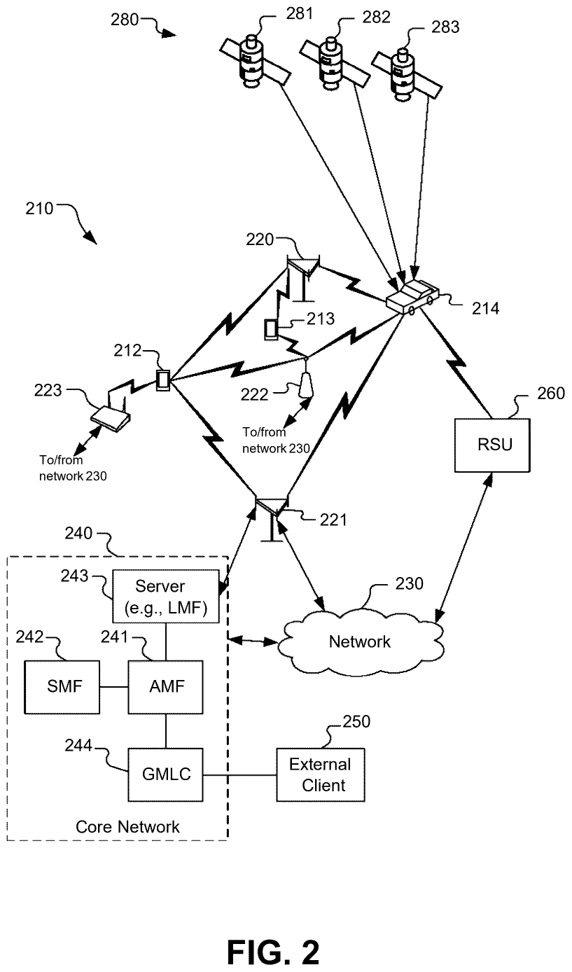

FIG. 1 is a block diagram of a device in the form of a UE 100. UE 100 may be an example of any of the UEs 212, 213, 214 (as shown in FIG. 2) or a UE in the form of a mobile device, such as a smart phone. UE 100 may include a computing platform including a processor 110, memory 111 including software (SW) 112, one or more sensors 113, a transceiver interface 114 for a transceiver 115 (that includes a wireless transceiver 140 and a wired transceiver 150), and a user interface 116. The processor 110, the memory 111, the sensor(s) 113, the transceiver interface 114, and the user interface 116 may be communicatively coupled to each other by a bus 120 (which may be configured, e.g., for optical and/or electrical communication). One or more of the components shown (e.g., one or more of the sensors 113, etc.) may be omitted from the UE 100.

The processor 110 may include one or more intelligent hardware devices, e.g., a central processing unit (CPU), a microcontroller, an application specific integrated circuit (ASIC), etc. The processor 110 may comprise multiple processors including a general-purpose/application processor 130, a Digital Signal Processor (DSP) 131, a modem processor 132, a video processor 133, and/or a sensor processor 134. One or more of the processors 130-134 may comprise multiple devices (e.g., multiple processors). For example, the sensor processor 134 may comprise one or more processors for processing data from RF-based sensors, ultrasound-based sensors, and/or light-based sensors, etc. The modem processor 132 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 100 for connectivity. The memory 111 is a non-transitory storage medium that may include random access memory (RAM), flash memory, disc memory, and/or read-only memory (ROM), etc. The memory 111 stores the software 112 which may be processor-readable, processor-executable software code containing instructions that are configured to, when executed, cause the processor 110 to perform various functions described herein. Alternatively, the software 112 may not be directly executable by the processor 110 but may be configured to cause the processor 110, e.g., when compiled and executed, to perform the functions. The description may refer only to the processor 110 performing a function, but this includes other implementations such as where the processor 110 executes software and/or firmware. The description may refer to the processor 110 performing a function as shorthand for one or more of the processors 130-134 performing the function. The description may refer to the UE 100 performing a function as shorthand for one or more appropriate components of the UE 100 performing the function. The processor 110 may include a memory with stored instructions in addition to and/or instead of the memory 111. Functionality of the processor 110 is discussed more fully below.

The configuration of the UE 100 shown in FIG. 1 is an example and not limiting of the aspects and features of the disclosure, including the claims, and other configurations may be used. For example, an example configuration of the UE includes one or more of the processors 130-134 of the processor 110, the memory 111, and the wireless transceiver 140. Other example configurations include one or more of the processors 130-134 of the processor 110, the memory 111, the wireless transceiver 140, and one or more of the sensors 113, the user interface 116, and/or the wired transceiver 150.

The UE 100 may comprise the modem processor 132 that may be capable of performing baseband processing of signals received and down-converted by the transceiver 115 and/or the SPS receiver 181 (discussed below). The modem processor 132 may perform baseband processing of signals to be upconverted for transmission by the transceiver 115. Also or alternatively, baseband processing may be performed by the processor 130 and/or the DSP 131. Other configurations, however, may be used to perform baseband processing.

The UE 100 includes the sensors 113 that may include one or more of various types of sensors, for example, an environmental sensor 160, a status sensor 170, and a position/motion/orientation (PMO) sensor 180. The PMO sensor 180 may include one or more sensors from which position and/or motion and/or orientation of the UE 100 may be determined. While each of the sensors 160, 170, 180 may be referred to in the singular, each of the sensors 160, 170, 180 may include more than one sensor, examples of some of which are discussed explicitly herein. The sensors 113 may generate analog and/or digital signals indications of which may be stored in the memory 111 and processed by the processor 110 (e.g., the processor 130, the DSP 131, the video processor 133, and/or the sensor processor 134 as appropriate) in support of one or more applications such as, for example, applications directed to positioning, navigation, and/or resource management. The description herein may refer to the processor 110 generally as performing one or more functions that one or more of the processors 130-134 perform.

The sensor(s) 113 may be used in resource management, relative location measurements, relative location determination, motion determination, etc. Information detected by the sensor(s) 113 may be used to determine how to allocate resources of the UE 100, e.g., transmission power, processing power for transmission and/or reception of communication signals, transmission and/or reception directionality, etc. The plural term “resources” is often used throughout the discussion herein, but this term includes the singular as well, i.e., a single resource, e.g., being allocated. Also or alternatively, information detected by the sensor(s) may be used for motion detection, relative displacement, dead reckoning, sensor-based location determination, and/or sensor-assisted location determination. The sensor(s) 113 may be useful to determine whether the UE 100 is fixed (stationary) or mobile and/or whether to report certain useful information to the server 243 (as shown in FIG. 2) regarding the mobility of the UE 100. For example, based on the information obtained/measured by the sensor(s) 113, the UE 100 may notify/report to the server 243 of FIG. 2 that the UE 100 has detected movements or that the UE 100 has moved, and report the relative displacement/distance (e.g., via dead reckoning, or sensor-based location determination, or sensor-assisted location determination enabled by the sensor(s) 113). In another example, for relative positioning information, the sensors/IMU can be used to determine the angle, size (e.g., width and/or height), and/or orientation of another device with respect to the UE 100, etc. The position and/or motion of the UE 100 may be used in determining resource allocation for communication, e.g., between vehicles. The UE 100 may, for example, be disposed in or integrated with a vehicle. For example, the UE 100 may be the UE 214 of FIG. 2, which is a vehicle (e.g., a car) in the example shown in FIG. 2. Other forms of UEs or vehicles may be used, such as trucks (e.g., a delivery vehicle), air-based UEs (e.g., an alternative delivery vehicle, such as a drone), etc. As such, the UE 100 may be configured for various forms of communication, e.g., V2V (vehicle-to-vehicle), V2X (vehicle-to-everything), CV2X (cellular V2X), CV2V (cellular V2V), etc.

The environmental sensor 160 may include one or more sensors for measuring one or more internal and/or external environmental conditions. In this example, the environmental sensor 160 includes a camera 161, a microphone 162, an air-flow sensor 163, a temperature sensor 164, a motion sensor 165, and a light-based sensor 166. While each of the sensors 161-166 may be referred to in the singular, each of the sensors 161-166 may include more than one sensor, examples of some of which are discussed explicitly herein. For example, the camera 161 may include at least one camera configured (e.g., designed, made, disposed, and directed) to capture images external to the UE 100 and/or may include one or more cameras configured to capture images internal to the UE 100 (e.g., in a passenger compartment of a vehicle). As other examples, the microphone 162, the temperature sensor 164, and/or the motion sensor 165 may include multiple microphones, multiple thermometers, and/or multiple motion detectors configured to detect sound, temperature, and/or motion (respectively) outside and/or inside of the UE 100, e.g., a vehicle. Indeed, any of the sensors 161-165 may include multiple respective sensors outside the vehicle and/or multiple respective sensors inside the vehicle for making respective measurements at multiple locations about the vehicle and/or in different directions relative to the vehicle. While this discussion assumes the UE 100 is a vehicle, the UE 100 may be a different device (i.e., other than a vehicle). The sensors 161-165 are examples and one or more of the sensors 161-165 may be omitted from the UE 100 and/or one or more other sensors may be included in the UE 100. For example, the environmental sensor 160 may include one or more barometric pressure sensors and/or one or more ambient light sensors and/or one or more other sensors.

The camera 161 may be configured for capturing still and/or moving imagery. For example, each camera of the camera 161 may comprise, for example, one or more imaging sensors (e.g., a charge coupled device (CCD) or a CMOS imager), one or more lenses, analog-to-digital circuitry, frame buffers, etc. Additional processing, conditioning, encoding, and/or compression of signals representing captured images may be performed by the general-purpose processor 130 and/or the DSP 131. Also or alternatively, the video processor 133 may perform conditioning, encoding, compression, and/or manipulation of signals representing captured images. The video processor 133 may decode/decompress stored image data for presentation on a display device (not shown), e.g., of the user interface 116.

The motion detector 165 is configured to detect motion. For example, the motion detector 165 may send and receive sound waves (e.g., ultrasound signals) and analyze the received signals for Doppler effects indicative of motion. Use of multiple motion detectors may help identify the relative location (e.g., direction relative to the UE 100) of an object.

The light-based sensor 166 is configured to determine range to an object, which may be used by the processor 110 to detect the presence of an object. Use of multiple light-based sensors may help identify the relative location (e.g., direction relative to the UE 100) of an object. In some cases, the light-based sensor 166 may be used for detecting relatively small objects such as vehicles or other artificial (human-made) objects.

The status sensor 170 is configured to provide one or more indications of one or more UE conditions of the UE 100 indicative of UE status. For example, UE conditions where the UE 100 is a vehicle (with UE conditions thus being vehicle conditions) may include a gear status of the vehicle (e.g., whether the vehicle is in park, drive, or neutral, or in which gear the vehicle is presently (e.g., reverse, first, second, third, fourth, etc.)). Another vehicle condition may be whether an emergency brake is engaged. Another vehicle condition may be whether a main brake is presently engaged and possibly engaged to what degree. Another vehicle condition may be whether an accelerator is presently engaged and possibly to what degree. Another vehicle condition may be the status of the steering wheel (e.g., turned which way and how much) and/or wheel(s) directing the vehicle (e.g., direction of front wheels). Other example vehicle conditions may include whether a right-turn indicator is actuated, whether a left-turn indicator is actuated, and/or whether hazard lights (also called “four ways” or emergency flashers, etc.) are actuated. Another example vehicle condition may include tire status (e.g., tire pressure, rate of tire pressure change (e.g., to indicate a flat or blowout)). Another example vehicle condition is speed, e.g., as registered by a speedometer of the vehicle and/or determined by other means (e.g., using the PMO sensor 180). These vehicle conditions are examples, and one or more other sensors may be provided to sense one or more other vehicle conditions. Further, numerous other UE conditions may be sensed and indicated where the UE 100 is not a vehicle or is not associated with a vehicle.

The PMO sensor 180 may include one or more sensors for providing one or more UE conditions such as, for example, vehicle conditions. For example, the PMO sensor 180 may include one or more sensors for measuring information from which position and/or motion and/or orientation of the UE 100 may be determined and possibly determining position and/or motion (e.g., speed and/or direction of motion) and/or orientation of the UE 100. In this example, the PMO sensor 180 includes a Satellite Positioning System (SPS) receiver 181, a position device (PD) 182, an Inertial Measurement Unit (IMU) 183, and a magnetometer 184. The components of the PMO sensor 180 shown are examples, and one or more of these components may be omitted and/or one or more other components included in the PMO sensor 180. Also, while each of the components 181-184 of the PMO sensor 180 may be referred to in the singular, each of the components 181-184 may include more than one such component, examples of some of which are discussed explicitly herein. Also, the PD 182 may be part of the SPS receiver 181 and/or the IMU 183 and/or part of the processor 110, and may not be a sensor itself (e.g., may not take measurements), but may process information from one or more of the sensors 181, 183, 184 and/or one or more other sensors. The PMO 180 may be used to determine UE speed and/or direction of motion, e.g., by determining UE location over time (e.g., determined using SPS, one or more ranging sensors, etc.).

The IMU 183 may comprise one or more inertial sensors, for example, an accelerometer 187 (e.g., responding to acceleration of the UE 100 in three dimensions) and/or a gyroscope 188. While each of the sensors 187, 188 may be referred to in the singular, each of the sensors 187, 188 may include more than one sensor. The accelerometer may include one or more three-dimensional accelerometers and the gyroscope may include one or more three-dimensional gyroscopes. The IMU 183 may be configured to provide measurements about a direction of motion and/or a speed of motion of the UE 100, which may be used, for example, in relative location determination. For example, the accelerometer 187 and/or the gyroscope 188 of the IMU 183 may detect, respectively, a linear acceleration and a speed of rotation of the UE 100. The linear acceleration and speed of rotation measurements of the UE 100 may be integrated over time (e.g., by the IMU 183 and/or the PD 182) to determine an instantaneous direction of motion as well as a displacement of the UE 100. The instantaneous direction of motion and the displacement may be integrated to track a location of the UE 100. For example, a reference location of the UE 100 may be determined, e.g., using the SPS receiver 181 (and/or by some other means) for a moment in time and measurements from the accelerometer 187 and the gyroscope 188 taken after this moment in time may be used in dead reckoning to determine a present location of the UE 100 based on movement (direction and distance) of the UE 100 relative to the reference location.

The magnetometer 184 may determine magnetic field strengths in different directions which may be used to determine orientation of the UE 100, which may be used, for example, to provide a digital compass for the UE 100. The magnetometer 184 may include a two-dimensional magnetometer configured to detect and provide indications of magnetic field strength in two orthogonal dimensions. Also or alternatively, the magnetometer 184 may include a three-dimensional magnetometer configured to detect and provide indications of magnetic field strength in three orthogonal dimensions. The magnetometer 184 may provide means for sensing a magnetic field and providing indications of the magnetic field (e.g., to the processor 110). The magnetometer 184 may provide measurements to determine orientation (e.g., relative to magnetic north and/or true north) that may be used for any of a variety of purposes (e.g., to support one or more compass applications). While referred to in the singular, the magnetometer 184 may include multiple magnetometers.

The SPS receiver 181 (e.g., a Global Positioning System (GPS) receiver or other Global Navigation Satellite System (GNSS) receiver) may be capable of receiving and acquiring SPS signals 185 via an SPS antenna 186. The antenna 186 is configured to transduce the wireless SPS signals 185 to wired signals (e.g., electrical or optical signals, and may be integrated with the antenna 146). The SPS receiver 181 may be configured to process, in whole or in part, the acquired SPS signals 185 for estimating a location of the UE 100. For example, the SPS receiver 181 may be configured to determine location of the UE 100 by trilateration using the SPS signals 185. The general-purpose processor 130, the memory 111, the DSP 131 and/or one or more specialized processors (not shown) may be utilized to process acquired SPS signals, in whole or in part, and/or to calculate an estimated location of the UE 100, in conjunction with the SPS receiver 181. The memory 111 may store indications (e.g., measurements) of the SPS signals 185 and/or other signals (e.g., signals acquired from the wireless transceiver 140) for use in performing positioning operations. The general-purpose processor 130, the DSP 131, and/or one or more specialized processors, and/or the memory 111 may provide or support a location engine for use in processing measurements to estimate a location of the UE 100. Also or alternatively, some or all of the position determination signal processing may be performed by the PD 182.

The position device (PD) 182 may be configured to determine a position of the UE 100 (including absolute and/or relative position of the UE 100), motion of the UE 100, and/or time. For example, the PD 182 may communicate with, and/or include some or all of, the SPS receiver 181. The PD 182 may use measurements from the SPS receiver 181 and/or the IMU 183 and/or the magnetometer 184 to determine position and/or motion of the UE 100, e.g., using trilateration and/or dead reckoning. The PD 182 may work in conjunction with the processor 110 and the memory 111 as appropriate to perform at least a portion of one or more positioning methods (to determine location of the UE 100), although the description herein may refer only to the PD 182 being configured to perform, or performing, one or more operations in accordance with the positioning method(s). The PD 182 may also or alternatively be configured to determine location of the UE 100 using terrestrial-based signals (e.g., at least some of signals 148 discussed below) for trilateration, for assistance with obtaining and using the SPS signals 185, or both. The PD 182 may be configured to use one or more other techniques (e.g., relying on the UE's self-reported location (e.g., part of the UE's position beacon)) for determining the location of the UE 100, and may use a combination of techniques (e.g., SPS and terrestrial positioning signals) to determine the location of the UE 100. The PD 182 may be configured to provide indications of uncertainty and/or error in the determined position and/or motion. Functionality of the PD 182 may be provided in a variety of manners and/or configurations (e.g., by the general purpose/application processor 130, the transceiver 115, the SPS receiver 181, and/or another component of the UE 100, and may be provided by hardware, software, firmware, or various combinations thereof).

The transceiver 115 may include a wireless transceiver 140 and/or a wired transceiver 150 configured to communicate with other devices through wireless connections and wired connections, respectively. For example, the wireless transceiver 140 may include a wireless transmitter 142 and a wireless receiver 144 coupled to one or more antennas 146 for transmitting (e.g., on one or more uplink channels and/or one or more sidelink channels) and/or receiving (e.g., on one or more downlink channels and/or one or more sidelink channels) wireless signals 148 and transducing signals from the wireless signals 148 to wired (e.g., electrical and/or optical) signals and from wired signals to the wireless signals 148. The wireless transceiver 140 may be configured for wireless communication to send communications to, and receive communications from, a variety of entities such as other UEs, base stations, etc. Thus, the wireless transmitter 142 may include multiple transmitters that may be discrete components or combined/integrated components, and/or the wireless receiver 144 may include multiple receivers that may be discrete components or combined/integrated components. The wireless transceiver 140 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 150 may include a wired transmitter 152 and a wired receiver 154 configured for wired communication, e.g., a network interface that may communicate with the network 230 of FIG. 2, e.g., to send communications to, and receive communications from, a gNB, for example. The wired transmitter 152 may include multiple transmitters that may be discrete components or combined/integrated components, and/or the wired receiver 154 may include multiple receivers that may be discrete components or combined/integrated components. The wired transceiver 150 may be configured, e.g., for optical communication and/or electrical communication. The transceiver 115 may be communicatively coupled to the transceiver interface 114, e.g., by optical and/or electrical connection. The transceiver interface 114 may be at least partially integrated with the transceiver 115.

The wireless transceiver 140 may be configured for beam management to affect directionality of the wireless transceiver 140, e.g., of the antenna 146. For example, the wireless transceiver 140 may be configured to implement beam forming for transmission and/or reception of the signals 148. The antenna 146 may include multiple antennas that are configured, e.g., designed, made, disposed, and directed to point in different directions relative to a body of the UE 100. One or more of such antennas may be capable of electronic beam steering (e.g., using appropriate phase shifts of elements of the antenna) and/or mechanical beam steering. Also or alternatively, the transceiver 140 may be configured to selectively (e.g., under direction/control of the processor 110) transmit from one or more antennas and/or to selectively process signals (e.g., to pass from the transceiver 115 to the processor 110 or to process by the processor 110) received from one or more antennas.

The user interface 116 may comprise one or more of several devices such as, for example, a speaker, microphone, display device, vibration device, keyboard, touch screen, etc. The user interface 116 may include more than one of any of these devices. The user interface 116 may be configured to enable a user to interact with one or more applications hosted by the UE 100. For example, the user interface 116 may store indications of analog and/or digital signals in the memory 111 to be processed by DSP 131 and/or the general-purpose processor 130 in response to action from a user. Similarly, applications hosted on the UE 100 may store indications of analog and/or digital signals in the memory 111 to present an output signal to a user. The user interface 116 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 116 may comprise one or more touch sensors responsive to touching and/or pressure, e.g., on a keyboard and/or touch screen of the user interface 116.

FIG. 2 illustrates an example wireless communications system 210. Wireless communications system 210 includes a user equipment (UE) 212, a UE 213, a UE 214, base transceiver stations (BTSs) 220, 221, 222, 223, a network 230, a core network 240, an external client 250, and a roadside unit (RSU) 260. The core network 240 (e.g., a 5G core network (5GC)) may include back-end devices including, among other things, an Access and Mobility Management Function (AMF) 241, a Session Management Function (SMF) 242, a server 243, and a Gateway Mobile Location Center (GMLC) 244. The AMF 241, the SMF 242, the server 243, and the GMLC 244 are communicatively coupled to each other. The server 243 may be, for example, a Location Management Function (LMF) that supports positioning of the UEs 212-214 (e.g., using techniques such as Assisted Global Navigation Satellite System (A-GNSS), OTDOA (Observed Time Difference of Arrival, e.g., Downlink (DL) OTDOA and/or Uplink (UL) OTDOA), Round Trip Time (RTT), Multi-Cell RTT, RTK (Real Time Kinematic), PPP (Precise Point Positioning), DGNSS (Differential GNSS), E-CID (Enhanced Cell ID), AoA (Angle of Arrival), AoD (Angle of Departure), etc.). The RSU 260 may be configured for communication (e.g., bi-directional or uni-directional communication) with the UEs 212-214). For example, the RSU 260 may be configured with similar communication capabilities to any of the BTSs 220-223, but perhaps with different functionality(ies) (e.g., different programming). Also, while one RSU 260 is shown in FIG. 2, the system 200 may include more than one RSU, or may not include any RSUs. The communication system 210 may include additional or alternative components.

The communication system 210 may utilize information from a constellation 280 of satellite vehicles (SVs) 281, 282, 283. The constellation 280 may correspond to a respective Global Navigation Satellite System (GNSS) (i.e., Satellite Positioning System (SPS)) such as the Global Positioning System (GPS), the GLObal NAvigation Satellite System (GLONASS), Galileo, Beidou, or some other local or regional SPS such as the Indian Regional Navigational Satellite System (IRNSS), the European Geostationary Navigation Overlay Service (EGNOS), or the Wide Area Augmentation System (WAAS). Only three SVs are shown for the constellation 280, but constellations of GNSS SVs will include more than three SVs.

An LMF may also be referred to as a Location Manager (LM), a Location Function (LF), a commercial LMF (CLMF), or a value-added LMF (VLMF). The server 243 (e.g., an LMF) and/or one or more other devices of the system 210 (e.g., one or more of the UEs 212-214) may be configured to determine locations of the UEs 212-214. The server 243 may communicate directly with the BTS 221 (e.g., a gNB) and/or one or more other BTSs, and may be integrated with the BTS 221 and/or one or more other BTSs. The SMF 242 may serve as an initial contact point of a Service Control Function (SCF) (not shown) to create, control, and delete media sessions. The server 243 (e.g., an LMF) may be co-located or integrated with a gNB or a TRP (Transmission/Reception Point), or may be disposed remote from the gNB and/or TRP and configured to communicate directly or indirectly with the gNB and/or the TRP.

The AMF 241 may serve as a control node that processes signaling between the UEs 212-214 and the core network 240, and provides QoS (Quality of Service) flow and session management. The AMF 241 may support mobility of the UEs 212-214 including cell change and handover and may participate in supporting signaling connection to the UEs 212-214.

The system 210 is capable of wireless communication in that components of the system 210 can communicate with one another (at least some times using wireless connections) directly or indirectly, e.g., via the BTSs 220-223 and/or the network 230 (and/or one or more other devices not shown, such as one or more other base transceiver stations). While the BTSs 220-223 are shown separately from the network 230, the network 230 may include one or more of the BTSs 220-223 and may constitute a Radio Access Network (RAN), e.g., a New Radio (NR) RAN which may also be called a Fifth Generation (5G) Next Generation (NG) RAN (NG-RAN). For indirect communications, the communications may be altered during transmission from one entity to another, e.g., to alter header information of data packets, to change format, etc. The UEs 212-214 may communicate with the BTSs 220-223 via Uu interfaces, e.g., in RRC-encapsulated LPP messages (Radio Resource Control encapsulated LTE Positioning Protocol messages) over Uu interfaces. The UEs 212-214 shown are a smartphone, a tablet computer, and a vehicle-based device, but these are examples only as the UEs 212-214 are not required to be any of these configurations, and other configurations of UEs may be used. The UEs 212-214, the BTSs 220-223, the network 230, the core network 240, and/or the external client 250. For example, such other devices may include internet of thing (IoT) devices, medical devices, home entertainment and/or automation devices, etc. The core network 240 may communicate with the external client 250 (e.g., a computer system), e.g., to allow the external client 250 to request and/or receive location information regarding the UEs 212-214 (e.g., via the GMLC 244).

The UEs 212-214 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.81p, etc.). V2X communications may be cellular (Cellular-V2X (C-V2X)) and/or WiFi (e.g., DSRC (Dedicated Short-Range Connection)). The system 210 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTSs 220-223 may wirelessly communicate with the UEs 212-214 in the system 210 via one or more antennas. A BTS may also be referred to as a base station, an access point, a gNode B (gNB), an access node (AN), a Node B, an evolved Node B (eNB), etc. For example, each of the BTSs 220, 221 may be a gNB or a transmission point gNB, the BTS 222 may be a macro cell (e.g., a high-power cellular base station) and/or a small cell (e.g., a low-power cellular base station), and the BTS 223 may be an access point (e.g., a short-range base station configured to communicate with short-range technology such as WiFi, WiFi-Direct (WiFi-D), Bluetooth®, Bluetooth®-low energy (BLE), Zigbee, etc. One or more of the BTSs 220-223 may be configured to communicate with the UEs 212-214 via multiple carriers. Each of the BTSs 220, 221 may provide communication coverage for a respective geographic region, e.g., a cell. Each cell may be partitioned into multiple sectors as a function of the base station antennas.

The BTSs 220-223 each comprise one or more Transmission/Reception Points (TRPs). For example, each sector within a cell of a BTS may comprise a TRP, although multiple TRPs may share one or more components (e.g., share a processor but have separate antennas). The system 210 may include only macro TRPs or the system 210 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

The UEs 212-214 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, Ultrawideband (UWB), and so on. One or more of a group of the UEs 212-214 utilizing D2D communications may be within a geographic coverage area of a TRP such as one or more of the BTSs 220-223. Other UEs in such a group may be outside such geographic coverage areas, or be otherwise unable to receive transmissions from a base station. Groups of the UEs 212-214 communicating via D2D communications may utilize a one-to-many (1:M) system in which each UE may transmit to other UEs in the group. A TRP of the BTSs 220-223 may facilitate scheduling of resources for D2D communications. In other cases, D2D communications may be carried out between UEs without the involvement of a TRP.

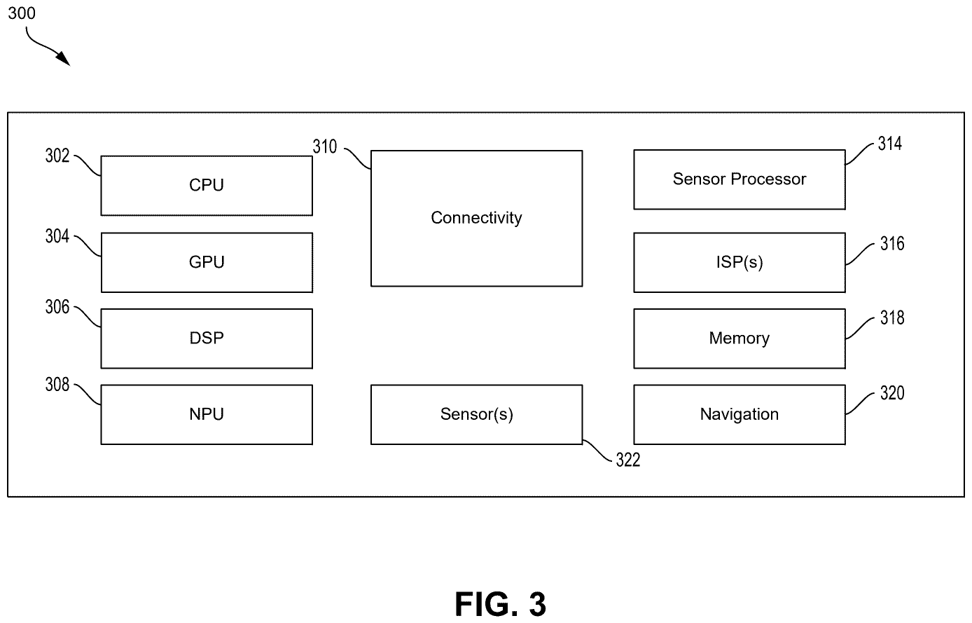

FIG. 3 illustrates an example implementation of a system-on-a-chip (SOC) 300, which may include a central processing unit (CPU) 302 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 308, in a memory block associated with a CPU 302, in a memory block associated with a graphics processing unit (GPU) 304, in a memory block associated with a digital signal processor (DSP) 306, in a memory block 318, and/or may be distributed across multiple blocks. Instructions executed at the CPU 302 may be loaded from a program memory associated with the CPU 302 or may be loaded from a memory block 318.

The SOC 300 may also include additional processing blocks tailored to specific functions, such as a GPU 304, a DSP 306, a connectivity block 310, which may include fifth generation (5G) connectivity, fourth generation long term evolution (4G LTE) connectivity, Wi-Fi connectivity, USB connectivity, Bluetooth connectivity, Ultrawideband (UWB) and the like. In one implementation, the NPU is implemented in the CPU 302, DSP 306, and/or GPU 304. The SOC 300 may also include a sensor processor 314, image signal processors (ISPs) 316, and/or navigation module 320, which may include a global navigation satellite system (GNSS) and/or global positioning system (GPS).

SOC 300 and/or components thereof may be configured to evaluate environmental conditions. For example, the sensor processor 314 may receive and/or process information from one or more sensors 322. Examples of sensors 322 may include one or more Inertial Measurement Units (IMUs) (e.g., an accelerometer, a gyroscope, etc.), temperature sensors, light sensors, shock sensors, humidity sensors, acceleration sensors, speed sensors, tilt angle sensors, etc. sensors of a device. In some cases, the sensors 322 may be located on SOC 300. In other cases, the sensor processor 314 may also be coupled to one or more sensors (not shown) that are external to the SOC 300 (e.g., located on a separate chip). In some cases, the sensor processor 314 may also receive, as input, output of one or more processing blocks of the connectivity block 310.

As previously mentioned, devices, including computing devices and servers, can communicate with each other via communications protocols. CoAP is one such communications protocol that is used for these types of communications. CoAP is a widely used application protocol designed for a constrained (e.g., low power and lossy) network including constrained nodes. The nodes often have eight (8)-bit microcontrollers with small amounts of read-only memory (ROM) and random-access memory (RAM), while constrained networks such as Internet Protocol Version 6 (IPv6) over Low-Power Wireless Personal Area Networks (6LoWPANs) often have high packet error rates and a typical throughput of tens (10s) of kilobits (kbit) per second (kbit/s). CoAP is designed for machine-to-machine (M2M) applications, such as smart energy and building automation applications.

CoAP is designed to easily interface with HTTP for integration within the world wide web (WWW), while meeting specialized requirements such as providing multicast support, a very low overhead, and simplicity for constrained environments. Similar to HTTP, CoAP is based on a request-response model. There are currently many IoT devices that use this protocol for communication with a server within a network.

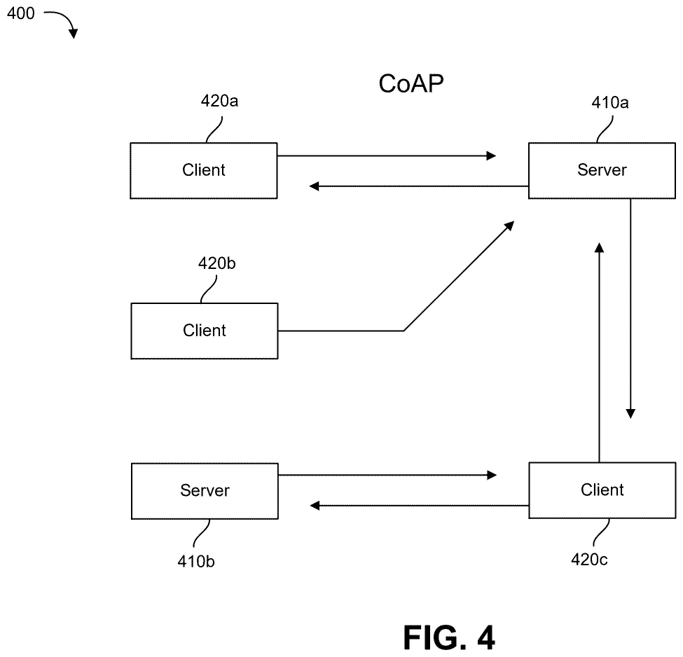

FIG. 4 shows an example of communications via a communications protocol (e.g., CoAP). In particular, FIG. 4 is a diagram illustrating an example of wireless communications 400 between devices 420a, 420b, 420c (e.g., clients) and servers 410a, 410b via a communications protocol, such as CoAP. The example of FIG. 4 shows communications between devices 420a, 420b, 420c and servers 410a, 410b using CoAP. In one or more examples, the devices 420a, 420b, 420c may be various different types of computing devices including, but not limited to, a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a personal computer, a laptop computer, a television (e.g., a network-connected television), a vehicle (or a computing device or system of a vehicle), user equipment, or other device.

As shown in FIG. 4, CoAP has a one-to-one communications architecture, where communications directly transmitted from a server 410a, 410b to a device 420a, 420b, 420c, or from a device 420a, 420b, 420c to a server 410a, 410b. The one-to-one communications architecture generally does not employ a middle element, such as a relay device, between the transmissions. CoAP uses a user datagram protocol (UDP), which is connectionless and, as such, can allow for a lower power consumption, than that of protocols that use transmission control protocol (TCP)-based connections. As opposed to a TCP-based protocol, CoAP has the advantage of being connectionless, which means that communications can occur between two endpoints without a prior arrangement. CoAP is suited for systems that monitor state changes, where state information can be transferred between devices 420a, 420b, 420c and servers 410a, 410b. The simplicity of being connectionless allows for CoAP to have low-latency and provide for an efficient data transfer, which can be ideal for time-sensitive applications, such as video conferencing, online gaming, and voice over IP (VoIP).

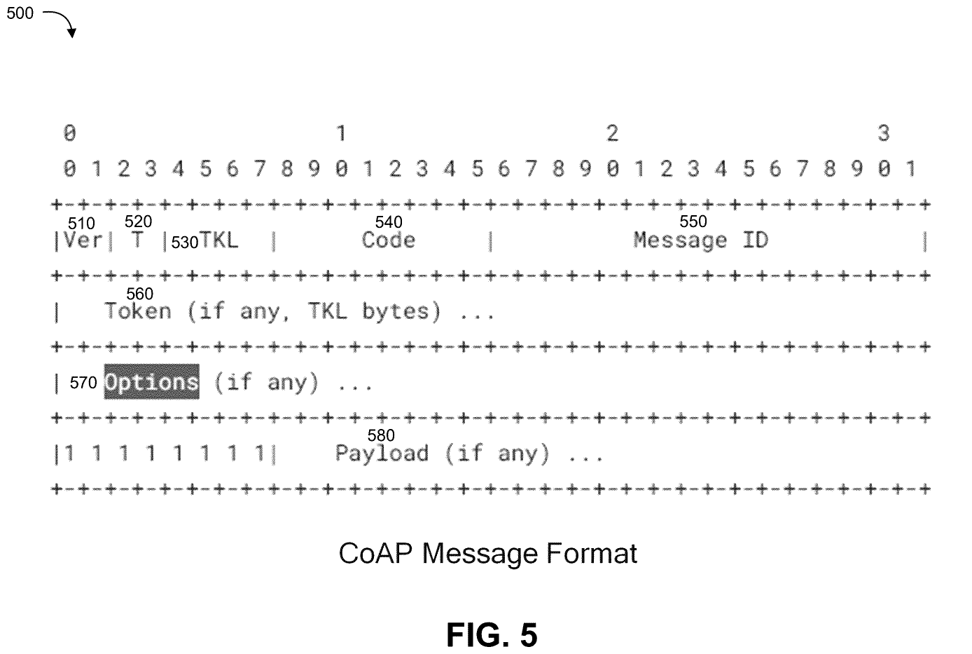

CoAP is based on the exchange of compact messages that, by default, are transported over UDP (e.g., each CoAP message occupies the data section of one UDP datagram). CoAP messages are encoded in a simple binary format (e.g., message format 500 of FIG. 5).

FIG. 5 shows an example communications protocol message format. In particular, FIG. 5 is a diagram illustrating an example of a message format 500 for a communications protocol, such as CoAP. The example of FIG. 5 shows an example of a message format 500 for CoAP. In FIG. 5, the message format 500 starts with a fixed-size 4-byte header. The header includes a number of fields, including a version field 510, a type (T) field 520, a token length (TKL) field 530, a code field 540, and a message identification (ID) field 550.

The version field 510 is a two (2)-bit unsigned integer that indicates the CoAP version number. The token field 520 is a 2-bit unsigned integer that indicates whether the message is a type confirmable (0), a type non-confirmable (1), an acknowledgement (2), or a reset (3). The token length field 530 is a four (4)-bit unsigned integer that indicates the length of the variable-length token field (e.g., 0 to 8 bytes). The code field 540 is an eight (8)-bit unsigned integer that is split into a 3-bit class (e.g., the most significant bits) and a 5-bit detail (e.g., the least significant bits). The class can indicate a request (0), a success response (2), a client error response (4), or a server error response (5). The message ID field 550 is a sixteen (16)-bit unsigned integer (in network byte order) that is used to detect message duplication and to match messages of type acknowledgement/reset to messages of type confirmable/non-confirmable.

The header is followed by a variable-length token value (e.g., within a token field 560), which can be between zero (0) and eight (8) bytes long. The token value is used to correlate requests and responses. Following the token value (e.g., within the token field 560) is a sequence of zero (0) or more CoAP options (e.g., within an options field 570) in a type-length-value (TLV) format. An option can be followed by the end of the message, by another option, or by a payload marker and a payload (e.g., within a payload field 580). The payload data extends from after the payload marker to the end of the UDP datagram (e.g., the payload length is calculated from the datagram size). The absence of the payload marker denotes a zero-length payload.

In one or more aspects, CoAP provides a request-response interaction model between application endpoints (e.g., devices and servers), supports built-in discovery of services and resources, and includes key concepts of the world wide web, such as uniform resource identifiers (URIs) and Internet media types. CoAP includes two types of response models, which include a piggybacked response and a separate response.

A device can send a piggybacked response, in response to receiving a request for data, when the device can obtain the data within a default amount of time (e.g., a default timeout) for responding to the request. For the piggybacked response, the device can transmit, within the default amount of time, a single response (e.g., a single data packet transmission) including both an acknowledgement (ACK) of receiving the request and the requested data.

A device can send a separate response, in response to receiving a request for data, when the device cannot obtain the data within a default amount of time for responding to the request. For example, the device may need additional time to obtain the requested data (e.g., sensor data, such as humidity sensor data, biosensor data, or other sensor data) because the device needs to perform a calibration or initialization (e.g., of the sensors, such as humidity sensors, biosensors, etc.) before reading the actual data values (e.g., sensor values, such as humidity sensor values, biosensor values, or values from other sensors). For a separate response, the device can transmit (prior to the expiration of the default amount of time) a first response including an acknowledgement of receiving the request (e.g., to notify the requestor that the device received the request, the device is working to obtain the requested data, and that the requestor does not need to retransmit the request to the device), and can transmit (after expiration of the default amount of time) a second response including the requested data.

These separate responses require double the amount of transmissions (e.g., require two data packet transmissions) than a piggybacked response (e.g., which requires only a single data packet transmission) and, as such, these additional transmissions of the separate responses can result in a large amount of congestion in the network traffic. For example, when separate responses are to be sent by a number of devices (e.g., clients) for requests from a server, then for every request from the server, there can be an acknowledgment sent followed by a response message with the requested data, which can increase the network traffic at the server side. Similarly, when a number of devices (e.g., clients) want to obtain some information (e.g., data) from a server at the same time, for every request sent by the devices, the server may send an acknowledgment followed by a response message with the requested data, which can also increase the network traffic. As such, when there are a large number of requests, these separate responses can increase the network traffic transmissions in the millions or even in the billions.

Therefore, improved systems and techniques that provide a response model for a communications protocol (e.g., CoAP) that can reduce the amount of traffic congestion within a network can be useful.

In one or more aspects, the systems and techniques can provide solutions for a variable timeout (e.g., within a response model) for congestion control in a communications protocol (e.g., CoAP). In one or more examples, the systems and techniques provide solutions for a communications protocol (e.g., CoAP) that utilize the capability of the piggybacked response method by introducing a new updated extended amount of time (e.g., an updated timeout) for a device to be able to transmit a single response including both the acknowledgment of receiving the request and the requested data. As such, the responding to the request can be performed by the device by using a single packet transfer (as opposed to a double packet transfer), even when the requested data is not available to the device prior to the expiration of the default amount of time for responding to the request.

In one or more examples, when a requestor (e.g., a server) is aware that the amount of time the device will need to for obtaining the data is greater than the default amount of time for responding to the request, the requestor can include within the request (e.g., configure the request to include) an indication of an extended amount of time for the device to respond to the request. This extended amount of time allows for the device to be able to send a piggybacked response (e.g., a single packet transfer), as opposed to a separate response (e.g., which requires a double packet transfer), to the requestor and, as such, there can be a reduction in the amount of transmissions within the network, which can lower the amount of traffic congestion within the network.

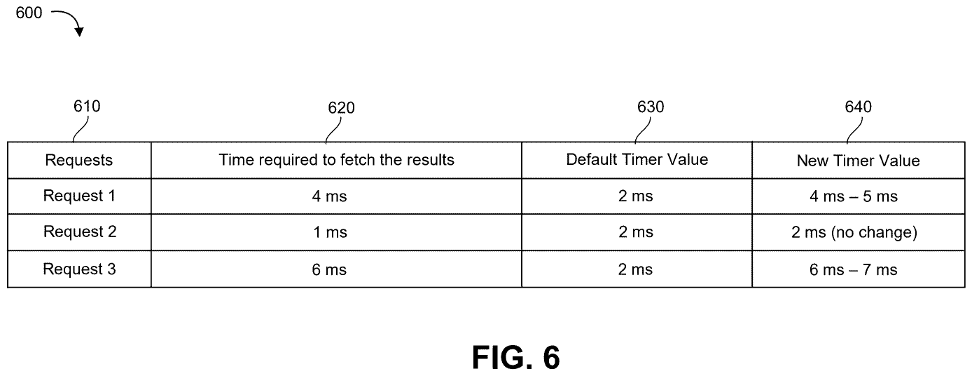

FIG. 6 shows different requests with indications of different amounts of time for responding to a request. Every request can have, as needed, a different amount of time for responding to the request. For example, the default amount of time (T) for responding to a request can be increased to an extended amount of time (T+X) for responding to a request. In particular, FIG. 6 is a table 600 illustrating an example of requests (e.g., Req 1, Req 2, and Req 3) with indications of different amounts of time to respond to the requests. In FIG. 6, the table 600 is shown to include a requests column 610, a time required to fetch (e.g., obtain) the results (e.g., data) column 620, a default timer value (e.g., default timeout) column 630, and a new timer value (e.g., an extended timeout) column 640.

As shown in the default timer value column 630 of FIG. 6, the default timer value (e.g., default amount of time) for all of the requests (Req 1, Req 2, and Req 3) is equal to two (2) milliseconds (ms). For the first request (Req 1), the time required for the device to obtain the data is equal to 4 ms and, as such, the request contains an updated timer value (e.g., an extended amount of time) of four (4) to five (5) ms for the device to send a response. For the second request (Req 2), the time required for the device to obtain the data is equal to only one (1) ms and, as such, the request simply indicates the default timer value (e.g., default amount of time) of 2 ms for the device to send a response. For the third request (Req 3), the time required for the device to obtain the data is equal to six (6) ms and, as such, the request contains an updated timer value of six (6) to seven (7) ms for the device to send a response.

In one or more examples, the new timer value (e.g., extended amount of time) can be indicated within a new response timeout (newResponseTimeout) option of the request. In some examples, the new response timeout option may be included within the options field 570 within the message format 500 for CoAP of FIG. 5.

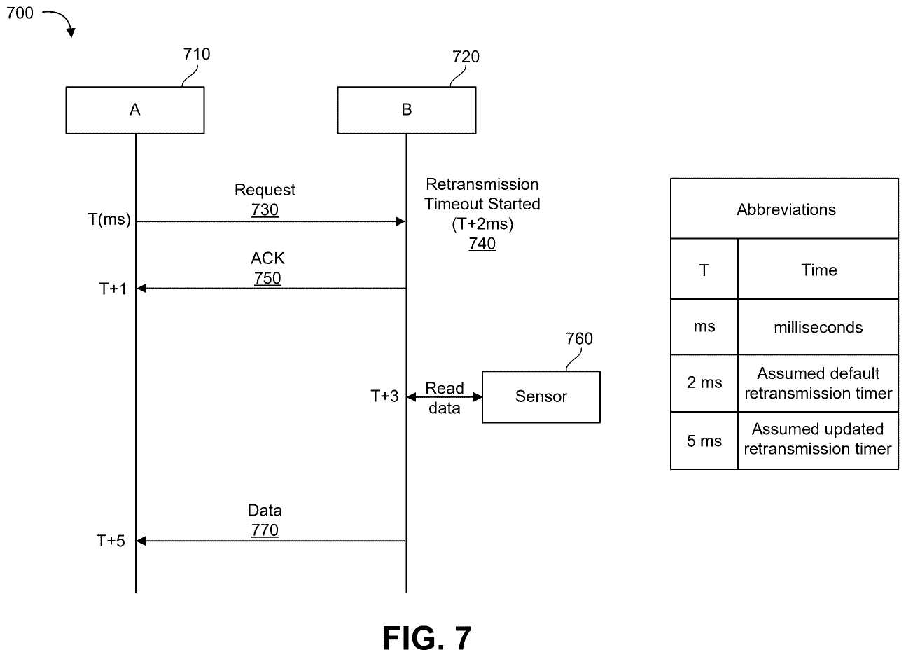

FIG. 7 shows example communications between devices with a request including an indication of a default amount of time for responding to the request, where the device is not able to obtain the requested data prior to expiration of the default amount of time. In particular, FIG. 7 is a signaling diagram showing an example of communications 700 between a first device 710 and a second device 720, where a request 730 from the first device 710 includes an indication of a default amount of time (e.g., T+2 ms) for the second device 720 to respond to the request 730. In FIG. 7, a first device 710 (e.g., device A) and a second device 720 (e.g., device B) are shown. In one or more examples, the first device 710 can be a computing device, and the second device 720 can be a server. In one or more examples, the first device 710 can be a server, and the second device 720 can be a computing device.

During operation of the communications 700 of FIG. 7, the first device 710 can transmit (e.g., at time T ms) a request 730 for data to the second device 720. The second device 720 can receive (e.g., with a retransmission timeout started for T+2 ms 740) the request 730 for data from the first device 710. In one or more examples, the request 730 can include an indication of a default amount of time (e.g., T+2 ms) for the second device 720 to respond to the request 730 with a response including both an acknowledgement (ACK) of receiving the request 730 and the requested data. The second device 720 can determine, based on receiving the request 730, whether a response including the acknowledgment and the data can be transmitted by the second device 720 within the default amount of time (e.g., T+2 ms).

The second device 720 can transmit (e.g., at T+1 ms), to the first device 710 based on determining a response including both the acknowledgement and the data cannot be transmitted within the default amount of time (e.g., T+2 ms), a response including the acknowledgment (ACK) 750 prior to the expiration of the default amount of time. The second device 720 can obtain or read (e.g., at T+3 ms) the requested data from a sensor 760 associated with the second device 720 or associated with another external device (e.g., a third device) connected to the second device 720. After obtaining the requested data, the second device 720 can transmit (e.g., at T+5 ms) a response including the requested data 770 to the first device 710.

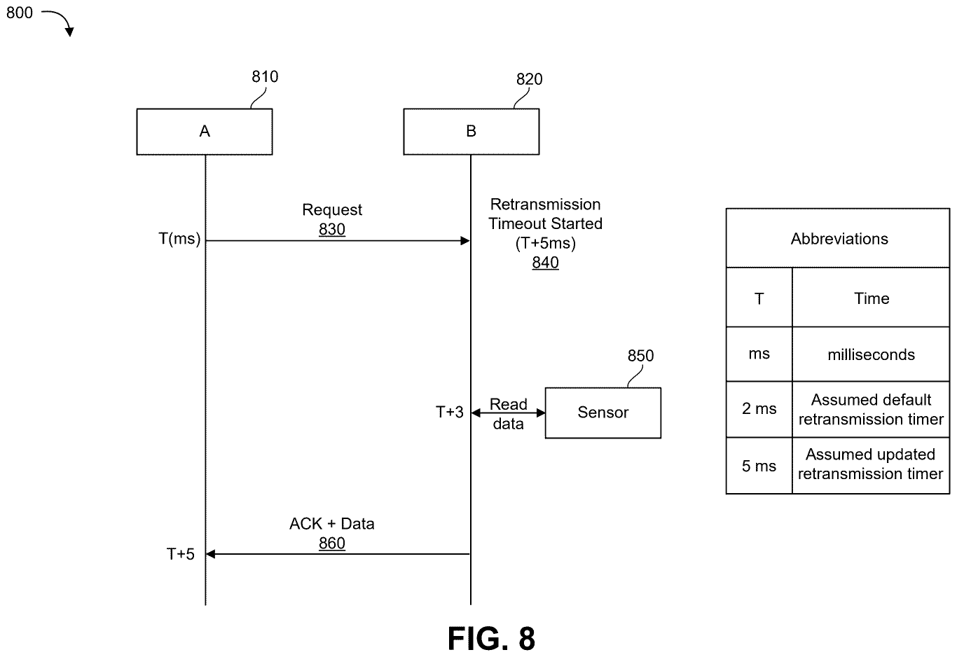

FIG. 8 shows example communications between devices with a request including an indication of an extended amount of time for responding to the request, where the device is able to obtain the requested data prior to expiration of the extended amount of time. In particular, FIG. 8 is a signaling diagram showing an example of communications 800 between a first device 810 and a second device 820, where a request 830 from the first device 810 includes an indication of an extended amount of time (e.g., T+5 ms) for the second device 820 to respond to the request 830, and the second device 820 transmits a response 860 including both an acknowledgement (ACK) and requested data together. In FIG. 8, a first device 810 (e.g., device A) and a second device 820 (e.g., device B) are shown. In one or more examples, the first device 810 can be a computing device, and the second device 820 can be a server. In one or more examples, the first device 810 can be a server, and the second device 820 can be a computing device.

During operation of the communications 800 of FIG. 8, the first device 810 can transmit (e.g., at time T ms) a request 830 for data to the second device 820. The second device 820 can receive (e.g., with a retransmission timeout started for T+5 ms 840) the request 830 for data from the first device 810. In one or more examples, the request 830 can include an indication of an extended amount of time (e.g., T+5 ms) for the second device 820 to respond to the request 830 with a response including both an acknowledgement (ACK) of receiving the request 830 and the requested data.

The second device 820 can obtain or read (e.g., at T+3 ms) the requested data from a sensor 850 associated with the second device 820 or associated with another external device (e.g., a third device) connected to the second device 820. The second device 820 can determine, based on receiving the request 830, whether a response including the acknowledgment and the data can be transmitted by the second device 820 within the extended amount of time (e.g., T+5 ms). The second device 820 can transmit (e.g., at T+5 ms), to the first device 810 based on determining a response including the acknowledgment and the data can be transmitted within the extended amount of time, a response 860 including both the acknowledgement and the requested data prior to an expiration of the extended amount of time (e.g., T+5 ms).

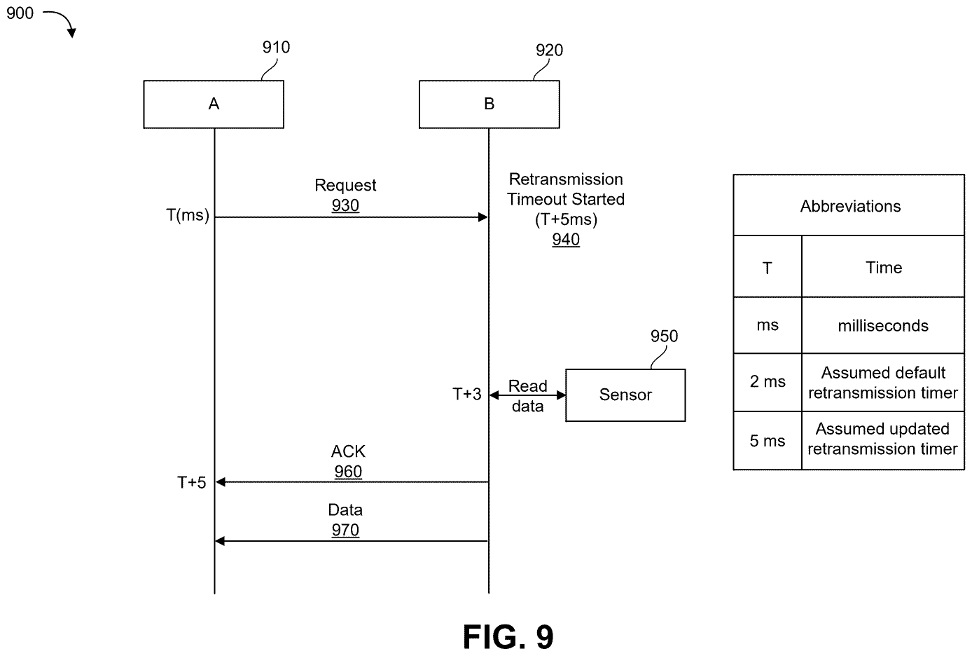

FIG. 9 shows example communications between devices with a request including an indication of an extended amount of time for responding to the request, where the device is not able to obtain the requested data prior to expiration of the extended amount of time. In particular, FIG. 9 is a signaling diagram showing an example of communications 900 between a first device 910 and a second device 920, where a request 930 from the first device 910 includes an indication of an extended amount of time (e.g., T+5 ms) for the second device 920 to respond to the request 930, and the second device 920 transmits a response including an ACK 960 and a subsequent response including requested data 970. In FIG. 7, a first device 910 (e.g., device A) and a second device 920 (e.g., device B) are shown. In one or more examples, the first device 910 can be a computing device, and the second device 920 can be a server. In one or more examples, the first device 910 can be a server, and the second device 920 can be a computing device.

During operation of the communications 900 of FIG. 9, the first device 910 can transmit (e.g., at time T ms) a request 930 for data to the second device 920. The second device 920 can receive (e.g., with a retransmission timeout started for T+5 ms 940) the request 930 for data from the first device 910. In one or more examples, the request 930 can include an indication of an extended amount of time (e.g., T+5 ms) for the second device 920 to respond to the request 930 with a response including both an acknowledgement (ACK) of receiving the request 930 and the requested data. The second device 920 can determine, based on receiving the request 930, whether a response including the acknowledgment and the data can be transmitted by the second device 920 within the extended amount of time (e.g., T+5 ms).

The second device 920 can obtain or read (e.g., at T+3 ms) the requested data from a sensor 950 associated with the second device 920 or associated with another external device (e.g., a third device) connected to the second device 920. The second device 920 can determine that a response including both the acknowledgement and the data cannot be transmitted within the extended amount of time (e.g., T+5 ms). In response to determining that the response including both the acknowledgement and the data cannot be transmitted within the extended amount of time, the second device 920 can transmit (e.g., at T+5 ms), to the first device 910, a response including the acknowledgment (ACK) 960 prior to the expiration of the extended amount of time. The second device 920 can then transmit (e.g., at a time that is later than T+5 ms, such as at T+6 ms) a response including the requested data 970 to the first device 910.

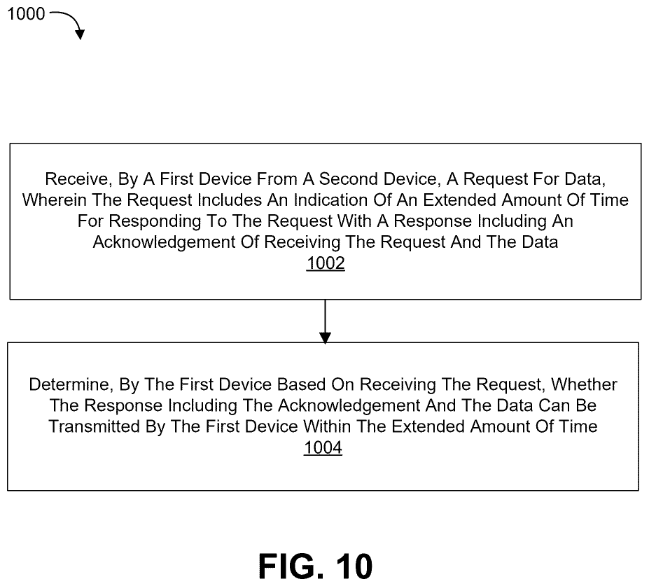

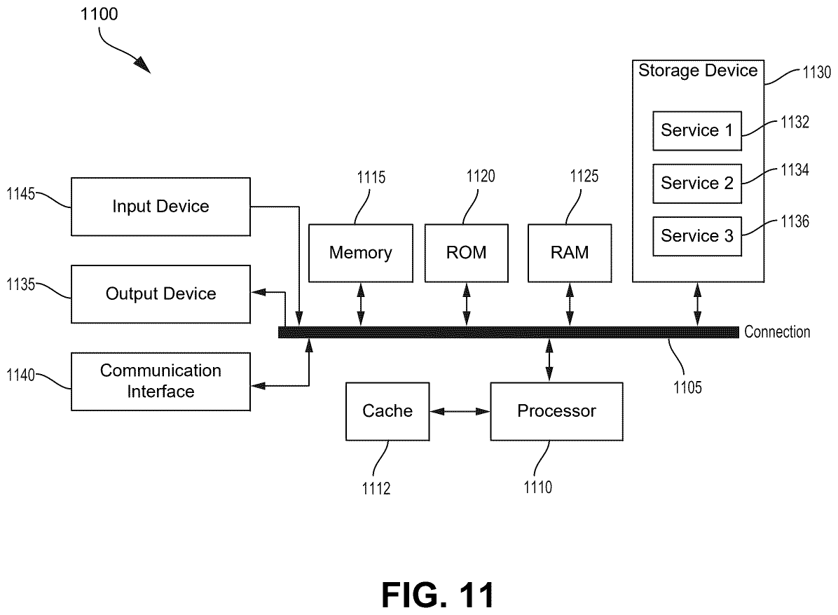

FIG. 10 is a flow chart illustrating an example of a process 1000 for a variable timeout for congestion control in a communications protocol, such as CoAP. The process 1000 can be performed by a computing device (e.g., a computing device or computing system 1100 of FIG. 11) or by a component or system (e.g., a chipset, one or more processors central processing units (CPUs), digital signal processors (DSPs), graphics processing units (GPUs), neural processing units (NPUs), any combination thereof, and/or other type of processor(s), or other component or system) of the computing device. The operations of the process 1000 may be implemented as software components that are executed and run on one or more processors (e.g., processor 1110 of FIG. 11, or other processor(s)). Further, the transmission and reception of signals by the computing device in the process 1000 may be enabled, for example, by one or more antennas and/or one or more transceivers (e.g., wireless transceiver(s)).

At block 1002, the computing device (or component thereof) can receive, from a second device, a request for data. In some aspects, the data is associated with the first device or a third device connected to the first device. In some cases, the first device is a computing device, and the second device is a server. In some cases, the first device is a server, and the second device is a computing device.

The request includes an indication of an extended amount of time for responding to the request with a response including an acknowledgement of receiving the request and the data. In some aspects, the extended amount of time for responding to the request is greater than a default amount of time for responding to the request. For instance, the default amount of time (T) for responding to a request can be increased to an extended amount of time (T+X) for responding to a request. In some cases, the extended amount of time for responding to the request is based on an amount of time required by the first device to obtain the data. In one illustrative example, as shown in the default timer value column 630 of FIG. 6, a default timer value (e.g., default amount of time) for a number of requests (Req 1, Req 2, and Req 3) is equal to two (2) milliseconds (ms). For the first request (Req 1), the time required for the device to obtain the data is equal to 4 ms and, as such, the request contains an updated timer value (e.g., an extended amount of time) of four (4) to five (5) ms for the device to send a response. For the second request (Req 2), the time required for the device to obtain the data is equal to only one (1) ms and, as such, the request simply indicates the default timer value (e.g., default amount of time) of 2 ms for the device to send a response. For the third request (Req 3), the time required for the device to obtain the data is equal to six (6) ms and, as such, the request contains an updated timer value of six (6) to seven (7) ms for the device to send a response. Various examples of using such an extended amount of time are described with respect to FIG. 8 and FIG. 9.

At block 1004, the computing device (or component thereof) can determine, based on receiving the request, whether the response including the acknowledgment and the data can be transmitted by the first device within the extended amount of time.

In some aspects, based on determining the response including the acknowledgment and the data can be transmitted within the extended amount of time, the computing device (or component thereof) can transmit (or output for transmission) the response to the second device with both the acknowledgement and the data prior to an expiration of the extended amount of time (e.g., as described with respect to FIG. 8).

In some cases, based on determining the response including the acknowledgement and the data cannot be transmitted within the extended amount of time, the computing device (or component thereof) can transmit (or output for transmission) the acknowledgment and the data to the second device in separate transmissions (e.g., as described with respect to FIG. 9). In some cases, the computing device (or component thereof) can transmit (or output for transmission) the data to the second device subsequent in time to the acknowledgement, as illustrated in FIG. 9. In some examples, the computing device (or component thereof) can transmit (or output for transmission) the acknowledgement to the second device prior to an expiration of the extended amount of time.

In some cases, the computing device (or component thereof) can transmit (or output for transmission) the request and the response via a communications protocol (e.g., a constrained application protocol (CoAP) or other communications protocol). In such cases, the indication of the extended amount of time is within an options field (e.g., options field 570 of FIG. 5) defined by the communications protocol.

In some cases, the computing device of process 1000 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1000 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a block diagram illustrating an example of a computing system 1100, which may be employed for a variable timeout for congestion control in a communications protocol, such as CoAP. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., LiDAR sensors, laser range finders, RF radars, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include
Aspect 1. A first device for wireless communications, the first device comprising: at least one memory; and at least one processor coupled to the at least one processor and configured to: receive, from a second device, a request for data, wherein the request comprises an indication of an extended amount of time for responding to the request with a response comprising an acknowledgement of receiving the request and the data; and determine, based on receiving the request, whether the response comprising the acknowledgment and the data can be transmitted by the first device within the extended amount of time.
Aspect 2. The first device of Aspect 1, wherein the at least one processor is configured to output, for transmission to the second device based on determining the response comprising the acknowledgment and the data can be transmitted within the extended amount of time, the response comprising the acknowledgement and the data prior to an expiration of the extended amount of time.
Aspect 3. The first device of any of Aspects 1 or 2, wherein the at least one processor is configured to output, for transmission to the second device based on determining the response comprising the acknowledgement and the data cannot be transmitted within the extended amount of time, the acknowledgment and the data in separate transmissions.
Aspect 4. The first device of Aspect 3, wherein the at least one processor is configured to output, for transmission to the second device, the data subsequent in time to the acknowledgement.
Aspect 5. The first device of any of Aspects 3 or 4, wherein the at least one processor is configured to output the acknowledgement for transmission prior to an expiration of the extended amount of time.
Aspect 6. The first device of any of Aspects 1 to 5, wherein the at least one processor is configured to output the request and the response for transmission via a communications protocol, and wherein the indication of the extended amount of time is within an options field defined by the communications protocol.
Aspect 7. The first device of Aspect 6, wherein the communications protocol is a constrained application protocol (CoAP).
Aspect 8. The first device of any of Aspects 1 to 7, wherein the extended amount of time for responding to the request is greater than a default amount of time for responding to the request.
Aspect 9. The first device of any of Aspects 1 to 8, wherein the extended amount of time for responding to the request is based on an amount of time required by the first device to obtain the data.
Aspect 10. The first device of any of Aspects 1 to 9, wherein the data is associated with the first device or a third device connected to the first device.
Aspect 11. The first device of any of Aspects 1 to 10, wherein the first device is a computing device, and the second device is a server.
Aspect 12. The first device of any of Aspects 1 to 11, wherein the first device is a server, and the second device is a computing device.
Aspect 13. A method of wireless communications, the method comprising: receiving, by a first device from a second device, a request for data, wherein the request comprises an indication of an extended amount of time for responding to the request with a response comprising an acknowledgement of receiving the request and the data; and determining, by the first device based on receiving the request, whether the response comprising the acknowledgment and the data can be transmitted by the first device within the extended amount of time.
Aspect 14. The method of Aspect 13, further comprising transmitting, by the first device to the second device based on determining the response comprising the acknowledgment and the data can be transmitted within the extended amount of time, the response comprising the acknowledgement and the data prior to an expiration of the extended amount of time.
Aspect 15. The method of any of Aspects 13 or 14, further comprising transmitting, by the first device to the second device based on determining the response comprising the acknowledgement and the data cannot be transmitted within the extended amount of time, the acknowledgment and the data in separate transmissions.
Aspect 16. The method of Aspect 15, wherein the first device transmits the data subsequent in time to the acknowledgement.
Aspect 17. The method of any of Aspects 15 or 16, wherein the first device transmits the acknowledgement prior to an expiration of the extended amount of time.
Aspect 18. The method of any of Aspects 13 to 17, wherein the request and the response are transmitted via a communications protocol, and wherein the indication of the extended amount of time is within an options field defined by the communications protocol.
Aspect 19. The method of Aspect 18, wherein the communications protocol is a constrained application protocol (CoAP).
Aspect 20. The method of any of Aspects 13 to 19, wherein the extended amount of time for responding to the request is greater than a default amount of time for responding to the request.
Aspect 21. The method of any of Aspects 13 to 20, wherein the extended amount of time for responding to the request is based on an amount of time required by the first device to obtain the data.
Aspect 22. The method of any of Aspects 13 to 21, wherein the data is associated with the first device or a third device connected to the first device.
Aspect 23. The method of any of Aspects 13 to 22, wherein the first device is a computing device, and the second device is a server.
Aspect 24. The method of any of Aspects 13 to 23, wherein the first device is a server, and the second device is a computing device.
Aspect 25. A non-transitory computer-readable medium having stored thereon instructions that, when executed by at least one processor, cause the at least one processor to perform operations according to any of Aspects 13 to 24.
Aspect 26. An apparatus for wireless communications, the apparatus including one or more means for performing operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A first device for wireless communications, the first device comprising:
at least one memory; and
at least one processor coupled to the at least one processor and configured to:
receive, from a second device, a request for data, wherein the request comprises an indication of an extended amount of time for responding to the request with a response comprising an acknowledgement of receiving the request and the data; and
determine, based on receiving the request, whether the response comprising the acknowledgment and the data can be transmitted by the first device within the extended amount of time.

2. The first device of claim 1, wherein the at least one processor is configured to output, for transmission to the second device based on determining the response comprising the acknowledgment and the data can be transmitted within the extended amount of time, the response comprising the acknowledgement and the data prior to an expiration of the extended amount of time.

3. The first device of claim 1, wherein the at least one processor is configured to output, for transmission to the second device based on determining the response comprising the acknowledgement and the data cannot be transmitted within the extended amount of time, the acknowledgment and the data in separate transmissions.

4. The first device of claim 3, wherein the at least one processor is configured to output, for transmission to the second device, the data subsequent in time to the acknowledgement.

5. The first device of claim 3, wherein the at least one processor is configured to output the acknowledgement for transmission prior to an expiration of the extended amount of time.

6. The first device of claim 1, wherein the at least one processor is configured to output the request and the response for transmission via a communications protocol, and wherein the indication of the extended amount of time is within an options field defined by the communications protocol.

7. The first device of claim 6, wherein the communications protocol is a constrained application protocol (CoAP).

8. The first device of claim 1, wherein the extended amount of time for responding to the request is greater than a default amount of time for responding to the request.

9. The first device of claim 1, wherein the extended amount of time for responding to the request is based on an amount of time required by the first device to obtain the data.

10. The first device of claim 1, wherein the data is associated with the first device or a third device connected to the first device.

11. The first device of claim 1, wherein the first device is a computing device, and the second device is a server.

12. The first device of claim 1, wherein the first device is a server, and the second device is a computing device.

13. A method of wireless communications, the method comprising:
receiving, by a first device from a second device, a request for data, wherein the request comprises an indication of an extended amount of time for responding to the request with a response comprising an acknowledgement of receiving the request and the data; and
determining, by the first device based on receiving the request, whether the response comprising the acknowledgment and the data can be transmitted by the first device within the extended amount of time.

14. The method of claim 13, further comprising transmitting, by the first device to the second device based on determining the response comprising the acknowledgment and the data can be transmitted within the extended amount of time, the response comprising the acknowledgement and the data prior to an expiration of the extended amount of time.

15. The method of claim 13, further comprising transmitting, by the first device to the second device based on determining the response comprising the acknowledgement and the data cannot be transmitted within the extended amount of time, the acknowledgment and the data in separate transmissions.

16. The method of claim 15, wherein the first device transmits the data subsequent in time to the acknowledgement.

17. The method of claim 15, wherein the first device transmits the acknowledgement prior to an expiration of the extended amount of time.

18. The method of claim 13, wherein the request and the response are transmitted via a communications protocol, and wherein the indication of the extended amount of time is within an options field defined by the communications protocol.

19. The method of claim 13, wherein the extended amount of time for responding to the request is greater than a default amount of time for responding to the request.

20. The method of claim 13, wherein the extended amount of time for responding to the request is based on an amount of time required by the first device to obtain the data.
